(19) United States
(12) Patent Application Publication
(10) Pub. No.: US 2024/0388746 A1
(43) Pub. Date: Nov. 21, 2024

(54) ENERGY-AWARE RENDERING AND DISPLAY PIPELINE FOR A MULTI-STREAM USER INTERFACE

(71) Applicant: GOOGLE LLC, Mountain View, CA (US)

(72) Inventors: Hee Jun Park, San Diego, CA (US); Figo Wang, Hsinchu City (TW); Amin Khajeh, Los Altos Hills, CA (US)

(21) Appl. No.: 18/198,787

(22) Filed: May 17, 2023

(51) Int. Cl. H04N 21/2343; H04N 21/234

(52) U.S. Cl. CPC H04N 21/234381; H04N 21/23418

(57) ABSTRACT

Systems and methods for generating a rendered composition for a multi-stream contents on a display are provided. One or more content item streams are received. Each content item stream is associated with a user experience metric. Based on the user experience metric, a rendering frames per second (FPS) metric for the plurality of content item streams is determined. A rendered composition of the plurality of content item streams is generated based on the rendering FPS metric.

### TECHNICAL FIELD

Aspects and implementations of the present disclosure relate to providing an energy-aware rendering and display pipeline for a multi-stream user interface (UI).

### BACKGROUND

A rendering and display pipeline refers to the series of steps involved in rendering and displaying graphical user interface elements on a display screen. The process receives image streams from multiple sources and combines them into a single rendered composition for display on the screen. The process can include rendering each image stream onto a buffer, and combining the buffers into a final representation of the user interface. The final version of the UI is then displayed on the screen. This process can be used for displaying a video conference, for example, or for simultaneously displaying multiple animation or video streams.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes receiving a plurality of content item streams. Each content item stream is associated with a user experience metric. The method further includes determining, based on the user experience metric, a rendering frames per second (FPS) metric for the plurality of content item streams. The method further includes generating a rendered composition of the plurality of content item streams based on the rendering FPS metric.

In some embodiments, generating the rendered composition of the plurality of content item streams based on the rendering FPS metric includes identifying, for each content item of the plurality of content item streams, one or more content frames. The method further includes identifying, for each content item stream, a most recent content frame of the one or more content frames. The method further includes, in response to determining, for each content item stream, that the most recent content frame satisfies a criterion, including the most recent content frame in the rendered composition. The criterion is satisfied in response to determining that the most recent content frame has not been included in a pervious rendered composition of the plurality of content item streams.

In some implementations, the method further includes determining a target refresh rate based on the rendering FPS metric.

In some implementations, the user experience metric reflects one of a minimum frame rate or a harmonic frame rate of the corresponding content item stream, determined over a period of time.

In some implementations, determining the rendering FPS metric for the plurality of content item streams includes determining, based on the user experience metric, a stabilized FPS metric for each content item stream. The method further includes identifying a display setting associated with a user interface displaying the plurality of content item streams. The method further includes determining, based on the display setting, a weighting factor for each content item stream. The method further includes combining the stabilized FPS metrics of the plurality of content item streams according to the weighting factors.

In some implementations, determining the stabilized FPS metric for each content item stream includes identifying, for each content item stream, a plurality of actual frame rates over a period of time. The method further includes identifying, for each content item stream, a lowest of the plurality of actual frame rates. In some implementations, the lowest of the plurality of actual frame rates satisfies a threshold condition.

In some implementations, the rendering FPS is one of: a highest of the stabilized FPS metrics of the plurality of content item streams, a lowest of the stabilized FPS metrics of the plurality of content item streams, a median of the stabilized FPS metrics of the plurality of content item streams, or an average of the stabilized FPS metrics of the plurality of content item streams.

In some implementations, generating the rendered composition of the plurality of content item streams includes synchronizing content frames from each content item stream based on the rendering FPS metric. The method further includes combining the synchronized content frames.

An aspect of the disclosure provides a system including a memory device and a processing device communicatively coupled to the memory device. The processing device performs operations including receiving a plurality of content item streams. Each content item stream is associated with a user experience metric. The processing device performs operations further including determining, based on the user experience metric, a rendering frames per second (FPS) metric for the plurality of content item streams. The processing device performs operations further including generating a rendered composition of the plurality of content item streams based on the rendering FPS metric.

In some implementations, to generate the rendered composition of the plurality of content item streams based on the rendering FPS metric, the processing device performs operations further including identifying, for each content item stream, one or more content frames. For each content item stream, the processing logic performs operations further including identifying, for each content item stream, a most recent content frame of the one or more content frames. The processing logic performs operations further including, responsive to determining, for each content item stream, that the most recent content frame satisfies a criterion, including the most recent content frame in the rendered composition. The criterion is satisfied responsive to determining that the most recent content frame has not been included in a previous rendered composition of the plurality of content item streams.

In some implementations, the processing device performs operations further including determining a target refresh rate based on the rendering FPS metric.

In some implementations, the user experience metric reflects one of a minimum frame rate or a harmonic frame rate of the corresponding content item stream, determined over a period of time.

In some implementations, to determine the rendering FPS metric for the plurality of content item streams, the processing device performs operations further including determining, based on the user experience metric, a stabilized FPS metric for each content item stream. The processing device performs operations further including identifying a display setting associated with a user interface displaying the plurality of content item streams. The processing device performs operations further including determining, based on the display setting, a weighting factor for each content item stream. The processing device performs operations further including combining the stabilized FPS metrics of the plurality of content item streams according to the weighting factors.

In some implementations, to determine the stabilized FPS metric for each content item stream, the processing device performs operations further including identifying, for each content item stream, a plurality of actual frame rates over a period of time. The processing device performs operations further including identifying, for each content item stream, a lowest of the plurality of actual frame rates. In some implementations, the lowest of the plurality of actual frame rates satisfies a threshold condition.

In some implementations, the rendering FPS is one of: a highest of the stabilized FPS metrics of the plurality of content item streams, a lowest of the stabilized FPS metrics of the plurality of content item streams, a median of the stabilized FPS metrics of the plurality of content item streams, or an average of the stabilized FPS metrics of the plurality of content item streams.

In some implementations, to generate the rendered composition of the plurality of content item streams, the processing device performs operations further including synchronizing content frames from each content item stream based on the rendering FPS metric. The processing device performs operations further including combining the synchronized content frames.

An aspect of the disclosure provides a computer program including instructions that, when the program is executed by a processing device, cause the processing device to perform operations including a plurality of content item streams. Each content item stream is associated with a user experience metric. The processing device performs operations further including determining, based on the user experience metric, a rendering frames per second (FPS) metric for the plurality of content item streams. The processing device performs operations further including generating a rendered composition of the plurality of content item streams based on the rendering FPS metric.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram illustrating an example rendering and display pipeline of a client device, in accordance with implementations of the present disclosure.

FIGS. 3A and 3B illustrate example user interfaces (UIs) of a video conference, in accordance with implementations of the present disclosure.

FIG. 4 illustrates a timeline for coalescing and synchronizing content frames from different streams, in accordance with implementations of the present disclosure.

FIG. 5 depicts a flow diagram of a method for generating a rendered composition of multiple content streams to display in a user interface, in accordance with implementations of the present disclosure.

FIG. 6 is a block diagram illustrating an exemplary computer system, in accordance with implementations of the present disclosure.

### DETAILED DESCRIPTION

Aspects of the present disclosure relate to providing an energy-aware rendering and display pipeline for a multi-stream user interface. A multi-stream user interface is a user interface that displays multiple animation and/or video content items simultaneously. Examples include a video conferencing application that displays multiple video streams, one for each participant; educational software that displays multiple animations or videos simultaneously to illustrate different concepts; a web page that displays a video and an animated advertisement simultaneously; media players that display multiple videos side-by-side; gaming interfaces that display videos representing each player's point of view in a multiplayer game, or that display a video of player's point of view as well as a video of an overview of the game.

Each of the content streams in a multi-stream UI display has a corresponding, and often dynamic, frames per second (FPS) metric. FPS metric or simply FPS may refer to the number of still images or frames displayed in one second of video or animation. Additionally, the content streams displayed in a multi-stream UI may have varying refresh rates. Refresh rate may refer to the frequency at which the image on screen is updated. Each content stream can have its own refresh timeline. Thus, two content streams that have matching FPS can be on differing refresh timelines. Conventional multi-stream UI display pipelines update the images on the screen as quickly as possible. As such, generating a rendered composition of multiple content streams that have different FPS and/or are on different refresh timelines can result in a final display that combines the FPS of all of the content streams. Thus, as a simple illustrative example, a composition of two content streams, each with 30 FPS, may have up to 60 frames per second if the refresh timelines of the content streams do not align. A composition of three content streams, each having 30 FPS, can have up to 120 FPS. As the number of FPS increases and the number of content streams displayed in a UI increases, the resulting FPS in the rendered composition also increases.

Such conventional multi-stream UI rendering and display pipelines consume an excessive amount of power, including thermal power. As video resolution increases and additional features are added to existing multi-stream user interfaces, conventional multi-stream UI rendering and display pipelines become increasingly inefficient, thermally unsustainable, and have increased latency. The power consumed to generate and display multi-stream UIs in such an inefficient manner negatively impacts the battery life of the device on which the UI is displayed, as well as the latency in displaying images.

Implementations of the present disclosure address the above and other deficiencies by providing a rendering and display pipeline for multi-content stream UI that coalesces and synchronizes the input frames to efficiently generate a rendered composition. In some embodiments, the components of rendering and display pipeline can include an application that receives multiple content streams, a software composer (e.g., a display manager or window manager) that manages the display, a display compositor (e.g., a hardware composer), and a display device. The features described herein can be implemented by the application, by the operating system, and/or by a server device in a cloud computing environment, for example.

The application can be any application that enables displaying two or more content streams (e.g., video and/or animation) simultaneously. The application can be, for example, part of a video conference platform. A video conference platform can enable video-based conferences between multiple participants via respective client devices that are connected over a network and share each other's audio (e.g., voice of a user recorded via a microphone of a client device) and/or video streams (e.g., a video captured by a camera of a client device) during a video conference. As another example, the application can be a content sharing platform that displays two or more video or animation content items simultaneously. As another example, the application can be a web browser that displays two or more video or animation content items.

The application can receive content streams (e.g., video streams, and/or animation streams) from multiple sources. For example, a video conference platform can receive video streams from the participants of the video conference. In some embodiments, the application can implement an energy-aware frame manager to efficiently render the content streams to the display device.

In some embodiments, the energy-aware frame manager can stabilize the frames per second of each image stream. Each image stream can have a corresponding dynamic frames per second. A dynamic FPS refers to the variation in the number of frames per second received in a continuous content stream. The frame rate of incoming content streams can vary due to factors such as network congestion, processing delays, or changes in lighting conditions, for example. The energy-aware frame manager can stabilize the FPS of each content stream based on the lowest frame rate detected over a period of time. Because the user experience tends to be affected by a lower bound of dynamically changing FPS, stabilizing the FPS of a content stream to the lower bound can provide a smooth video playback of the content stream. As an illustrative example, if over a period of 3 seconds, a dynamic FPS for a particular content stream ranges from 3 to 30 FPS, the energy-aware frame manager can stabilize the FPS for that particular content stream at 3 FPS. Stabilizing the FPS for a content stream includes adjusting the FPS for the content stream to the lower bound FPS over a period of time.

In some embodiments, the energy-aware frame manager can control the rendering FPS of the composition of video content streams. The rendering FPS can be a combination (e.g., an average) of the stabilized FPS of the content streams, a weighted combination (e.g., a weighted average) of the stabilized FPS of the content streams, the highest FPS of the stabilized FPS of the content streams, the lowest FPS of the stabilized FPS of the content streams, the median FPS of the stabilized FPS of the content streams, or an average FPS of the stabilized FPS of the content streams. The rendering FPS can be dependent on a display setting of the device on which the composition is to be displayed. The display setting can indicate which of the content streams is to be displayed larger than the others, for example. In this example, the rendering FPS can be the stabilized FPS of the content stream that is to be displayed larger than the others. Alternatively, the rendering FPS in this example can be a weighted average of the FPS of the stabilized FPS of the content streams, in which the stabilized FPS the content stream that is to be displayed larger is given more weight than the stabilized FPS of the other content streams. As another example, the display setting can indicate that all of the content streams are to be displayed in equal size. In this example, the rendering FPS can be an average of the stabilized FPS. Alternatively, the rendering FPS in this example can be the highest FPS of the FPS of the stabilized FPS of the content streams. The energy-aware frame manager can transmit the rendering FPS to a graphics rendering component, i.e., a software thread that is responsible for rendering graphics to the display.

In some embodiments, the energy-aware frame manager can coalesce and synchronize the content frames (e.g., image frames) from the different content streams. Synchronizing the content frames of the content streams can include aligning the images along a common timeline. Coalescing the content frames can include combining the content frames from the content streams, synchronized along a common timeline, into a final rendered composition. In some embodiments, the energy-aware frame manager can send a vote of a target display refresh rate matching the rendering FPS to the hardware compositor. The hardware compositor can aggregate the FPS votes to determine a VSYNC rate, and can cause the rendered composition to be displayed on the display device in accordance with the VSYNC rate. The VSYNC, or vertical sync, is used to synchronize the frame rate of the device's graphics card with the refresh rate of the monitor. Thus, the final rendered composition of the content streams is displayed using a VSYNC rate that matches, or closely matches, the rendering FPS.

Aspects of the present disclosure provide technical advantages over previous solutions. Aspects of the present disclosure can provide the additional functionality of generating a rendered composition of multiple video and/or animation content streams in an efficient manner. The FPS of each content item stream is stabilized to a consistent value that is based on a user's current experience. The user's experience can be based, for example, on the current network stability, network congestion, processing delays, current power consumption, and/or current thermal energy of the display device. Furthermore, the content streams are coalesced to generate a rendered composition based on the stabilized FPS of the content streams. Thus, the rendering and display pipeline generates a rendered composition that is in line with the users' experiences and avoids redundant and inefficient frame composition, resulting in a reduction in workload. Furthermore, by adjusting the FPS based on the user's current experience and generating a rendered composition based on the adjusted FPS, the device can be placed in low power mode (or sleep mode) for longer periods of time, and can spend less time in active mode. This results in a more efficient use of the processing resources utilized to generate and display the rendered composition. For example, the system-on-chip (SoC), memory, central processing unit (CPU), and graphics processing unit (GPU) can all experience a power reduction as a result of implementing the rendering and display pipeline described herein. Overall, implementing the features described herein reduces the power consumption of the device, improves the processing efficiency, and improves the thermal sustainability of the device. Furthermore, the reduction in power consumption extends the battery life of the device.

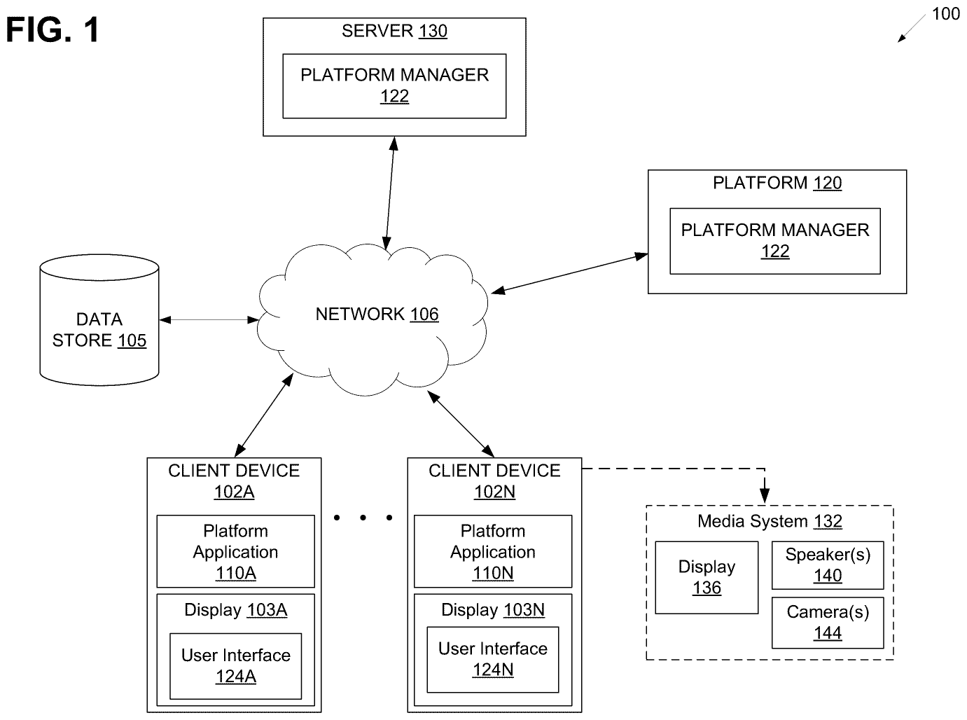

FIG. 1 illustrates an example system architecture 100, in accordance with implementations of the present disclosure. The system architecture 100 (also referred to as “system” herein) includes client devices 102A-N, a data store 105, a platform 120, and/or a server 130, each connected to a network 106. In some embodiments, platform 120 can be a video conference platform, which can enable video-based meetings between multiple participants via respective client devices 102A-N (e.g., that are connected over a network 106). In some embodiments, platform 120 can be a content sharing platform, which can enable users to upload, share, and view various forms of digital content, such as videos, images, audio files, documents, or other media. Platform 120 is not limited to these examples.

In implementations, network 106 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 105 is a persistent storage that is capable of storing data as well as data structures to tag, organize, and index the data. A data item can include audio data, video, and/or animation stream data, in accordance with embodiments described herein. Data store 105 can be hosted by one or more storage devices, such as main memory, magnetic or optical storage-based disks, tapes or hard drives, NAS, SAN, and so forth. In some implementations, data store 105 can be a network-attached file server, while in other embodiments data store 105 can be some other type of persistent storage such as an object-oriented database, a relational database, and so forth, that may be hosted by platform 120 or one or more different machines (e.g., the server 130) coupled to the platform 120 via network 106. In some implementations, the data store 105 can store portions of content streams (e.g., audio, video, and/or animation) streams received from the client devices 102A-N for the platform 120. Moreover, the data store 105 can store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.). These documents may be shared with users of the client devices 102A-N and/or concurrently editable by the users.

As an illustrative example, platform 120 can be a video conference platform that enables users of client devices 102A-N to connect with each other via a video conference. A video conference refers to a real-time communication session such as a video conference call, also known as a video-based call or video chat, in which participants can connect with multiple additional participants in real-time and be provided with audio and video capabilities. Real-time communication refers to the ability for users to communicate (e.g., exchange information) instantly without transmission delays and/or with negligible (e.g., milliseconds or microseconds) latency. Platform 120 can allow a user to join and participate in a video conference call with other users of the platform. Embodiments of the present disclosure can be implemented with any number of participants connecting via the video conference (e.g., from two participants up to one hundred or more).

The client devices 102A-N can each include computing devices such as personal computers (PCs), laptops, mobile phones, smart phones, tablet computers, netbook computers, network-connected televisions, etc. In some implementations, client devices 102A-N can also be referred to as “user devices.” Each client device 102A-N can include an audiovisual component that can generate audio and video data to be streamed to video conference platform 120. In some implementations, the audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-N. In some implementations, the audiovisual component can also include an image capture device (e.g., a camera) to capture images and generate video data (e.g., a video stream) of the captured data of the captured images.

In some embodiments, one or more of client devices 102A-N can be associated with a physical conference or meeting room. As an illustrative example, client device 102N may include or be coupled to a media system 132 that may comprise one or more display devices 136, one or more speakers 140 and one or more cameras 144. Display device 136 can be, for example, a smart display or a non-smart display (e.g., a display that is not itself configured to connect to network 106). Users that are physically present in the room can use media system 132 rather than their own devices (e.g., client device 102A) to participate in a video conference, which may include other remote users. For example, the users in the room that participate in the video conference may control the display 136 to show a slide presentation or watch slide presentations of other participants. Sound and/or camera control can similarly be performed. Similar to the other client devices (e.g., 102A), client device 102N can generate audio and video data to be streamed to platform 120 (e.g., using one or more microphones, speakers 140 and cameras 144).

Each client device 102A-N can include a platform application 110A-N, such as a web browser and/or a client application (e.g., a mobile application, a desktop application, etc.). In some implementations, the application 110A-N can present, on a display device 103A-103N of client device 102A-N, a user interface (UI) (e.g., a UI of the UIs 124A-N) for users to access platform 120. For example, a user of client device 102A can join and participate in a video conference via a UI 124A presented on the display device 103A by the application 110A-N. A user can also present a document to participants of the video conference via each of the UIs 124A-N. Each of the UIs 124A-N can include multiple regions to present visual items corresponding to video streams of the client devices 102A-N provided to the server 130 for the video conference.

In some implementations, server 130 can include a platform manager 122. In some embodiments, platform manager 122 is configured to manage a virtual meeting (e.g., a video conference) between multiple users of platform 120. In some implementations, manager 122 can provide the UIs 124A-N to each client device 102A-N to enable users to watch and listen to each other during a video conference. Platform manager 122 can also collect and provide data associated with the video conference to each participant of the video conference. In some implementations, platform manager 122 can provide the UIs 124A-N for presentation by a client application (e.g., a mobile application, a desktop application, etc.). For example, the UIs 124A-N can be displayed on a display device 103A-103N by a native application executing on the operating system of the client device 102A-N. The native application may be separate from a web browser.

In some embodiments, an audiovisual component of each client device can capture images and generate video data (e.g., a video stream) of the captured data of the captured images. In some implementations, the client devices 102A-N can transmit the generated video stream to platform manager 122. In some implementations, the client devices 102A-N can transmit the generated video stream directly to other client devices 102A-N participating in the video conference. The audiovisual component of each client device can also capture an audio signal representing speech of a user and generate audio data (e.g., an audio file or audio stream) based on the captured audio signal. In some implementations, the client devices 102A-N can transmit the generated audio data to platform manager 122, and/or directly to other client devices 102A-N.

The platform manager 122 and/or the platform application 110A-N can implement the energy-aware rendering and display pipeline features described herein. While implementations of the disclosure describe the pipeline features as being implemented by application 110A-N on a client device 102A-N, the pipeline (or portions of the pipeline) can be implemented by platform manager 122, on server 130 and/or on platform 120.

In some embodiments, the application 110A-N can receive content streams (e.g., video and/or animation streams) from client devices 102A-N, server 130, and/or platform 120. In some embodiments, the application 110A-N can access content streams stored in data store 105. The application 110A-N can identify a user experience metric associated with the client device 102A-N, and/or associated with the received content stream. The user experience metric can represent a current experience of the user. For example, the user experience metric can represent the power consumption of the client device 102A-N, the network stability or congestion of network 106, the dynamic FPS of the content item stream(s) generated by client device 102A-N, the current operating temperature of the client device 102A-N, and/or another metric that affects the experience of the user. In some embodiments, the user experience metric can represent the frame rate associated with the client device 102A-N.

The application 110A-N can stabilize the FPS of each content stream based on the user experience metric. In some embodiments, the user experience metric can be the frame rate of the content stream. In some embodiments, the application 110A-N can determine the actual frame rate for each content stream over a period of time. The application 110A-N can stabilize the FPS of each content stream to the lowest of the actual frame rates experienced of the period of time. In some embodiments, the application 110A-N can stabilize the FPS of a content stream by taking into account a power consumption level, network stability, operating temperature of the client device 102A-N, or any other factor of the user experience. As an illustrative example, if the user experience metric indicates that the power consumption is low, the operating temperature is low, and the network is not congested, the application 110A-N can stabilize the FPS of the content stream to the median actual frame rate measured over a period of time. On the other hand, if the user experience metric indicates that the power consumption is high, the operating temperature is high, and/or the network is congested, the application 110A-N can stabilize the FPS of the content stream to the lowest actual frame rate measured over a period of time. To stabilize the FPS of a content stream, the application 110A-N can adjust the actual, dynamic FPS to match the stabilized FPS value.

The application 110A-N can determine an overarching rendering FPS for the set of content streams. The rendering FPS can be based on the user experience metric of the corresponding client device 102A-N, and/or based on the stabilized FPS of the content streams.

In some embodiments, the application 110A-N can determine the user experience using artificial intelligence. Application 110A-N can include a trained machine learning model that can predict the user experience metric values. The machine learning model is trained using a training dataset that includes FPS patterns over a predetermined time period (e.g., 3 seconds), labeled with a corresponding user experience metric values. In some embodiments, the machine learning model can be trained on historical user experience values. In some embodiments, the machine learning model can be trained on historical FPS patterns combined with user experience values received as input from a user (e.g., users of client devices 102A-N). Once trained, the application 110A-N can use the machine learning model to determine the user experience metrics. The application 110A-N can provide as input FPS pattern (e.g., the dynamic FPS) over a period of time (e.g., 2 or 3 seconds). The application 110A-N can receive as output the user experience metric value.

In some embodiments, the application 110A-N can determine the rendering FPS using a trained machine learning model. The machine learning model can be trained using a training dataset that includes dynamic FPS values of content streams and/or stabilized FPS values of content item streams combined with user experience metrics, labeled with an optimal rendering FPS value. Once trained, the application 110A-N can use the machine learning model to determine the rendering FPS value for the content item streams. The application 110A-N can provide as input, the dynamic and/or stabilized FPS values of each content item stream, as well as the corresponding user experience metric. The application 110A-N can receive as output the rendering FPS for the set of content streams.

In some embodiments, the application 110A-N can include multiple machine learning (ML) models. As an example, the application 110A-N can include a rendering FPS ML model, trained to provide rendering FPS recommendations, and a user experience ML model, trained to provide user experience predictions. The rendering FPS ML model can receive, as input, FPS patterns over a predetermined time period for multiple content streams (e.g., content streams corresponding to each client device 102A-N). The rendering FPS ML model can provide, as output, rendering FPS recommendations. In some implementations, the application 110A-N can use the output of the rendering FPS ML model to determine the rendering FPS. Additionally or alternatively, the output of the rendering FPS ML model can be provided as input to machine the user experience ML model. Thus, the user experience ML model can receive rendering FPS metrics as input, and can provide, as output, a predicted user experience metric. The user experience ML model can be trained using a training dataset that includes rendering FPS metrics labeled with user experience values, and the rendering FPS model can be trained using a training dataset that includes FPS patterns over a predetermined time period labeled with user experience metric values.

In some embodiments, the application 110A-N can determine that the rendering FPS is the highest of the stabilized FPS values of the content streams, the lowest of the stabilized FPS values of the content streams, the median of the stabilized FPS values of the content streams, the average of the stabilized FPS values of the content streams, or a weighted average of the stabilized FPS values of the content streams. For example, the application 110A-N can have a setting that corresponds to the lowest of the stabilized FPS values, e.g., a power-saving mode. As another example, the application 110A-N can have a setting that corresponds to the user experience of the device 102A-N. For example, the client device 102A-N may be experiencing network congestion, in which case the application 110A-N can set the rendering FPS to match the lowest of the stabilized FPS values of the content streams. Alternatively, the user experience of the client device 102A-N may be experiencing a strong network connection and low power consumption, in which case the application 110A-N can set the rendering FPS to match the highest of the stabilized FPS values of the content streams. Thus, the application 110A-N can determine the rendering FPS based on the user experience, and/or based on the stabilized FPS values of the content streams.

In some embodiments, the application 110A-N can coalesce and synchronize the content streams. Coalescing the content streams includes combining the content frames into a single rendered composition, while synchronizing the content streams includes aligning the content frames according to a single timeline. The content streams can be coalesced and synchronized according to the rendering FPS.

In some embodiments, the application 110A-N can combine the content streams based on the rendering FPS to create the final display stream. The application 110A-N can determine the target refresh rate of the final display stream. The target refresh rate can match the rendering FPS, and/or can be based on the rendering FPS. The application 110A-N can transmit a VSYNC rate request to display 103A-N. Display 103A-N can then set the VSYNC rate, based on the VSYNC rate request. Display 103A-N can display the final display stream in user interface 124A-N based on the VSYNC rate.

It should be noted that in some other implementations, the functions of server 130 or platform 120 may be provided by a fewer number of machines. For example, in some implementations, server 130 may be integrated into a single machine, while in other implementations, server 130 may be integrated into multiple machines. In addition, in some implementations, server 130 may be integrated into platform 120.

In general, functions described in implementations as being performed by platform 120, and/or server 130 can also be performed by the client devices 102A-N in other implementations, if appropriate. In addition, the functionality attributed to a particular component can be performed by different or multiple components operating together. Platform 120 and/or server 130 can also be accessed as a service provided to other systems or devices through appropriate application programming interfaces, and thus is not limited to use in websites.

Although some implementations of the disclosure are discussed in terms of platform 120 and users of platform 120 participating in a video conference, implementations may also be generally applied to any type of telephone call or conference call between users. Implementations of the disclosure are not limited to video conference platforms that provide video conference tools to users. For example, implementations of the disclosure can be applied to content sharing platforms, web browser platforms, social media platforms, educational platforms, or any other platform that displays multiple video and/or animation content streams in a user interface.

In implementations of the disclosure, a “user” may be represented as a single individual. However, other implementations of the disclosure encompass a “user” being an entity controlled by a set of users and/or an automated source. For example, a set of individual users federated as a community in a social network may be considered a “user.” In another example, an automated consumer may be an automated ingestion pipeline, such as a topic channel, of the platform 120.

In situations in which the systems discussed here collect personal information about users, or may make use of personal information, the users may be provided with an opportunity to control whether application 110A-N or platform 120 collects user information (e.g., information about a user's social network, social actions or activities, profession, a user's preferences, or a user's current location), or to control whether and/or how to receive content from the application 110A-N or the server 130 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the application 110A-N, platform 120, and/or server 130.

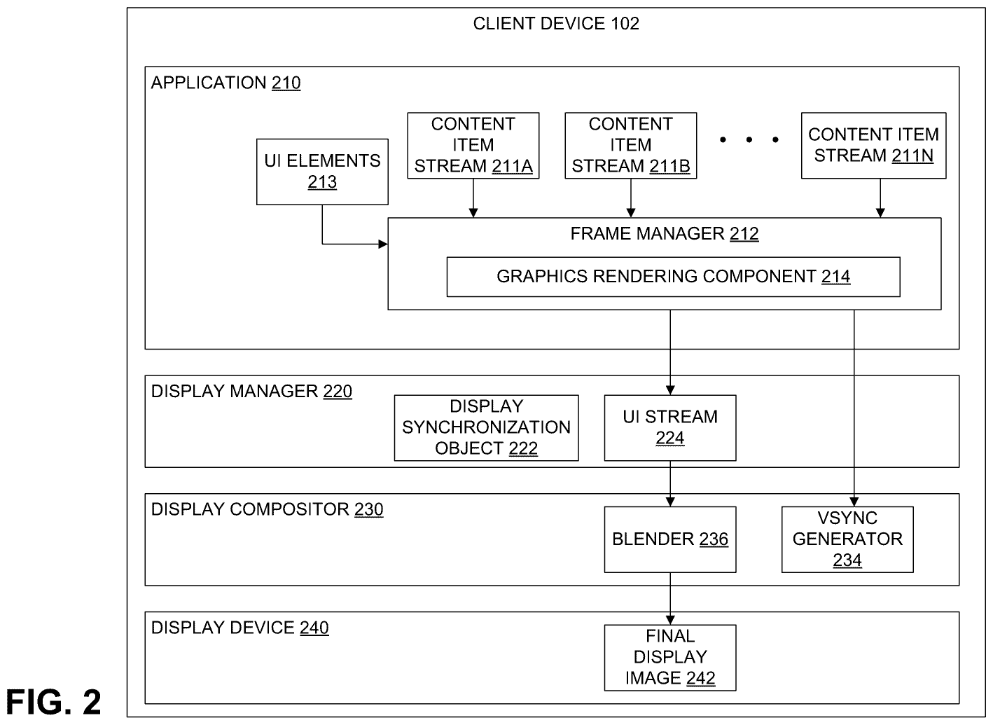

FIG. 2 is a block diagram illustrating an example rendering and display pipeline of a client device 102, in accordance with implementations of the present disclosure. The client device 102 includes an application 210, a display manager 220, a display compositor 230, and a display device 240. The components 210-240 can be combined together or separated into further components, according to a particular implementation. It should be noted that in some implementations, various components of the rendering and display pipeline illustrated in FIG. 2 may run on separate machines. For example, the frame manager 212 may be executed by platform manager 122 (e.g., on server 130 or platform 120 of FIG. 1). In embodiments, each of the components may be or include logic configured to perform a particular action or set of actions. In embodiments, one or more of the components may be combined into a single component. In embodiments, the functions of one or more components may be divided into sub-components.

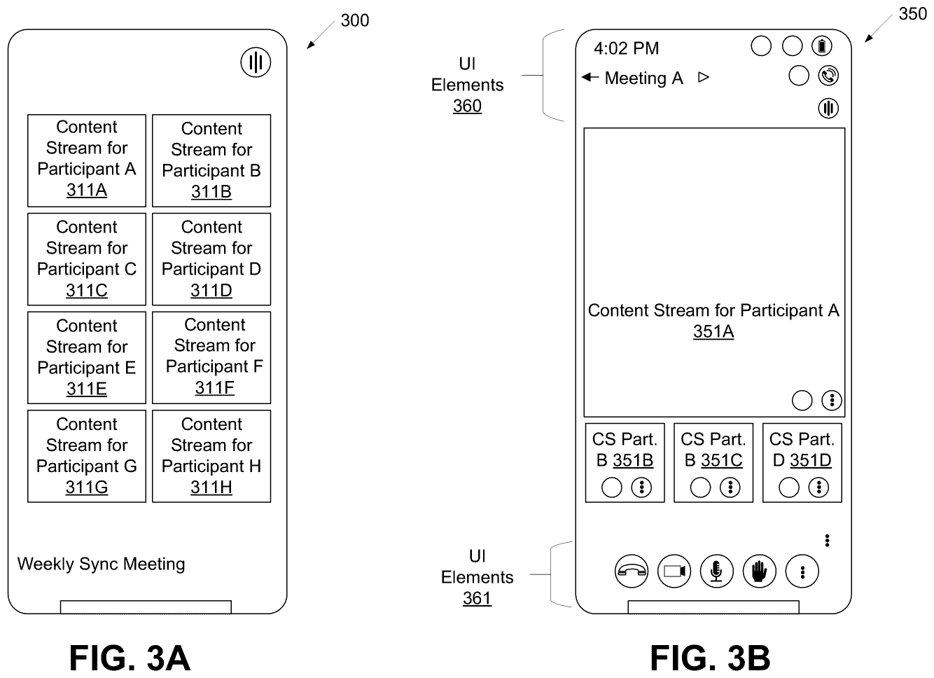

In some embodiments, application 210 can perform the same functions as platform application 110A-N of FIG. 1. In some embodiments, the application 210 can receive content item streams 211A-N from other client devices (e.g., from other client devices 102A-N of FIG. 1), from a server (e.g., from server 130 of FIG. 1), from a platform (e.g., platform 120 of FIG. 1), from other applications running on client device 102, from a data store (e.g., data store 105 of FIG. 1), and/or from the operating system of client device 102. In some embodiments, the application 210 can receive UI elements 213 as a content stream. In some embodiments, UI elements 213 can be generated by the operating system and can provide a content stream of the UI elements to be displayed in the final display image 242. For example, the call control panel portion of a user interface for a video conference can be considered a separate video stream. The call control panel typically appears at the bottom and/or top of the screen during a video conference call and provides users with access to controls. An example of UI elements 213 are illustrated in FIG. 3B. The content item streams 211A-N, 213 can be videos and/or animations. Each content item stream 211A-N, 213 can have a corresponding user experience metric that represents a current experience of the user. For example, the user experience metric can represent the power consumption of the client device 102, the network stability or congestion (e.g., of network 106 of FIG. 1), the dynamic FPS of the content item stream, the current operating temperature of the client device 102, and/or another metric that affects the experience of the user.

The frame manager 212 can receive the content item streams 211A-N, 213. In some embodiments, the UI elements 213 can be transmitted directly to the graphics rendering component 214. In some embodiments, the UI elements 213 can be transmitted to the frame manager 212 and treated as another content item stream.

The frame manager 212 can stabilize the FPS of each content item stream 211A-N, 213 based on a user experience metric. The frame manager 212 can stabilize the FPS of each content stream 211A-N, 213 to the lowest of the actual frame rates experienced of the period of time. In some embodiments, the frame manager 212 can stabilize the FPS of a content stream 211A-N, 213 by taking into account a power consumption level, network stability, operating temperature of the client device 102, or any other factor of the user experience. As an illustrative example, if the user experience metric indicates that the power consumption is low, the operating temperature is low, and the network is not congested, the frame manager 212 can stabilize the FPS of the content stream to the average actual frame rate measured over a period of time. On the other hand, if the user experience metric indicates that the power consumption is high, the operating temperature is high, and/or the network is congested, the frame manager 212 can stabilize the FPS of the content stream to the lowest actual frame rate measured over a period of time. To stabilize the FPS of a content stream, the frame manager 212 can adjust the actual, dynamic FPS to match the stabilized FPS value.

The graphics rendering component 214 can render the graphical elements of the UI. Graphical elements can include, for example, the content streams 211A-N, 213, as well as graphical elements related to views, surfaces, and textures of the UI. The graphics rendering component 214 can control the rendering FPS of the UI, e.g., based on the stabilized FPS of the content item streams 211A-N, 213.

The graphics rendering component 214 can coalesce and synchronize the content frames (e.g., image frames) from the content streams 211A-N, 213. For example, to synchronize the content frames, the graphics rendering component 214 can wait to receive a frame from each content item stream 211A-N (and optionally 213) before coalescing the frames. In some embodiments, the graphics rendering component 214 can place a time limit on how long to wait for a frame from each content item stream 211A-N, 213. For example, if content item stream 211A is experiencing a network failure, the graphics rendering component 214 may not wait to receive a content frame from content item stream 211A for more than a certain time period (e.g., 0.5 seconds). Once the graphics rendering component 214 has received a content frame from the content item stream 211A-N (and optionally 213), it can coalesce the content frames by combining the content frames into a single composition. This single composition can become UI stream 224.

The frame manager can send a vote (or request) of the target display refresh rate for the final display image 242 to VSYNC generator 234. The target display refresh rate can match rendering FPS, or can be based on the rendering FPS. For example, the display refresh rate can be limited to multiples of 10, and thus the target display refresh rate can be the multiple of 10 closest to the rendering FPS.

The display manager 220 can include a display synchronization object 222 and a UI stream 224. The UI stream 224 can be the composition of the coalesced and synchronized content stream streams 211A-N, and 213. The display synchronization object 222 component can synchronize the display of the frames of the UI stream 224 with the refresh of the display device 240. The refresh rate of the display device 240 can be determined by the VSYNC generator 234.

The display compositor 230 can combine the UI stream 224 with the outputs from other rendering stages, such as geometry processing, texturing, shading, and lighting, to create the final display image 242. The display compositor 230 (sometimes referred to as the hardware composer) can be integrated into the GPU of client device 102. The display compositor 230 can include a VSYNC generator 234 and a blender 236. The VSYNC generator 234 can receive VSYNC a vote or request, e.g., from the frame manager 212. In some embodiments, the VSYNC generator 234 can receive VSYNC votes or requests from other sources. The VSYNC, or vertical sync, is used to synchronize the frame rate of the device's graphics card with the refresh rate of the monitor (e.g., display device 240). The VSYNC generator 234 can adjust the VSYNC of the graphics card according to the requests received. In some embodiments, the VSYNC generator 234 can set the VSYNC to match the rendering FPS. In some embodiments, the VSYNC generator 234 can set the VSYNC to a value that most closely matches the rendering FPS.

The blender 236 can combine the UI stream 224 with the outputs of other rendering stages, by applying blending operations, such as alpha blending, additive blending, or multiplicative blending. The blender 236 can also apply different filters or effects to the rendered image, such as blurring or sharpening, to enhance the final image quality. The blender 236 can create the final display image 242 according to the frame rate generated by the VSYNC generator 234. The display device 240 can display the final display image 242 on client device 102.

FIGS. 3A and 3B illustrate example user interfaces 300, 350 for a video conference, in accordance with some embodiments of the present disclosure. In embodiments, the UIs 300, 350 can be generated by the client device 102A-N of FIG. 1. In some embodiments, the UIs 300, 350 can be generated by one or more processing devices of the server 130 of FIG. 1. In some implementations, the video conference between multiple participants can be managed by the platform manager 122 of FIG. 1.

As illustrated in FIG. 3A, the UI 300 displays a content stream (e.g., a video stream) corresponding to each participant A-H 311A-H. In this illustration, the video conference is displayed in full screen mode, and thus takes up the entire user interface display. Thus, in some embodiments, in determining the rendering FPS for the rendered composition, the frame manager 212 of FIG. 2 can use an average of the stabilized FPS of content stream 311A-H. In some embodiments, the frame manager 212 of FIG. 2 can use the lowest stabilized FPS of the content streams 311A-H, the highest stabilized FPS of the content streams 311A-H, or the median of the stabilized FPS of the content streams 311A-H, depending the user experience associated with content streams 311A-H, and/or associated with the device displaying UI 300.

As illustrated in FIG. 3B, the UI 350 displays a content stream (e.g., a video stream) corresponding to participants A-D 351A-D, however participant A 351A is displayed larger than the other participants. This display may be the result of using a highlight mode, where participant A 351A is highlighted or pinned (i.e., made larger than the other participants B-D 351B-D). This display may be the result of using the speaker mode, in which the speaker (e.g., participant A 351A) is made larger than the other participants B-D 351B-D). The participant made larger changes as the speaker changes. Based on one of these display settings (e.g., highlight, pin, or speaker setting), the frame manager 212 can determine the rendered FPS based on a weighted average of the stabilized FPS of the content streams corresponding to participants A-D 351A-D. For example, the frame manager 212 may assign more weight (e.g., 70%) to the stabilized FPS of content stream for participant A 351A, and less weight (e.g., 10%) to each of the stabilized FPS of content streams for participants B-D 351B-D. Note that these are only examples of display settings, and other display settings not described here are possible.

Additionally, the UI 350 displays additional UI elements 360, 361. UI elements 360, 361 can be, for example, the call control panel portion of a user interface for a video conference can be considered a separate content stream. The call control panel can appear at the bottom and/or top of the screen during a video conference call, and can provide users with access to controls. In some embodiments, these additional UI elements 360, 361 can be distinct content item streams. Content streams for UI elements 360, 361 can also have dynamic FPS. The frame manager 212 can incorporate the stabilized FPS of UI elements 360, 361 into the rendered FPS metric. For example, the frame manager 212 may assign a weight of 60% to the stabilized FPS of content stream for participant A 351 A, 10% to each of the stabilized FPS of content streams for participants B-D 351B-D, and can distribute the remaining 10% weight between the content streams for the additional UI elements 360, 361. The frame manager 212 can then generate a rendered composition that includes all the content streams using the rendered FPS metric.

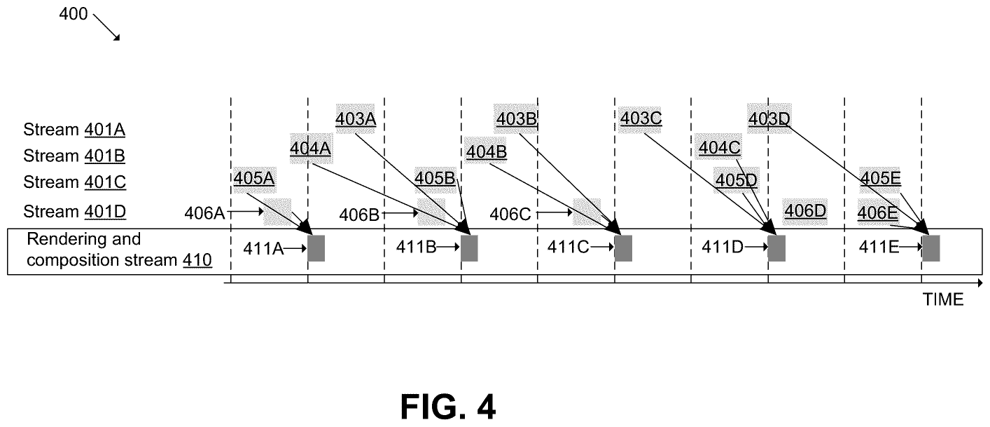

FIG. 4 illustrates a timeline 400 for coalescing and synchronizing the content frames from different streams, in accordance with some embodiments of the present disclosure. In some embodiments, four content streams 401A-D are received. As an illustrative example, content stream 401A can correspond to client device 102A of FIG. 1, content stream 401B can correspond to client device 102B of FIG. 1, and so on. As another illustrative example, content stream 401A can correspond to content stream for participant A 351A of FIG. 3B, content stream 401B can correspond to content stream for participant B 351B of FIG. 3B, content stream 401C can correspond to content stream for participant C 351C of FIG. 3B, and content stream 401D can correspond to content stream for participant D 351D of FIG. 3B. It should be noted that these are illustrative examples, the content streams 401A-D can correspond to any content streams in a multi-stream UI. Furthermore, while FIG. 4 illustrates four content streams, there can be more than, or fewer than, four content streams in a multi-stream UI, in accordance with some embodiments of the present disclosure.

Streams 401A-D can each have one or more input frame. The input content frames for stream 401A are illustrated as frames 403A-D. The input content frames for stream 401B are illustrated as frames 404A-C. The input content frames for stream 401C are illustrated as frames 405A-E. The input content frames for stream 401C are illustrated as frames 406A-E.

Streams 401A-D can each have a dynamic FPS. Frame manager 212 of FIG. 2 can stabilize the FPS of streams 401A-D. As an illustrative example, stream 401A can have a stabilized FPS of 24 FPS, stream 401B can have a stabilized FPS of 26 FPS, stream 401C can have a stabilized FPS of 20 FPS, and stream 401D can have a stabilized FPS of 22 FPS. The frame manager 212 of FIG. 2 can coalesce and synchronize the frames 403A-D, 404A-C, 405A-E, and 406A-E to generate the rendering and composition stream 410. Rendering and composition stream 410 can have a target display refresh rate of 30 FPS, and can include rendered content frames 411A-E.

As illustrated in FIG. 4, rendered image 411A includes frame 405A from stream 401C and frame 406A from stream 401D. Rendered image 411B includes frame 404A from stream 401B, frame 403A from stream 401A, image 406B from stream 401D, and stream 405B from stream 401C. Rendered image 411C includes frame 404B from stream 401B, frame 403B from stream 401A, and frame 406C from stream 401D. Because a frame was not received from stream 401C since the last composed frame 411B was generated, rendered image 411C does not include an image from stream 401C. By not including older frames (e.g., by not including frame 405B of stream 401C), fame manager 212 of FIG. 2 generates the rendering and composition stream 410 efficiently, which can lead to reduction in the power consumption of the device (e.g., device 102).

Rendered image 411D includes frame 403C from stream 401A, frame 404C from stream 401B, and frame 405D from stream 401C. Because a frame was not received from stream 401D since the last composed frame 411C was generated, rendered image 411D does not include an image from stream 401D. Rendered image 411E includes frame 403D from stream 401A, frame 405E from stream 401C, and frame 406E from stream 401D. Because a frame was not received from stream 401B since the last composed frame 411D was generated, rendered image 411E does not include an image from stream 401B. It should be noted that frame 411E does not include frame 406D. Frame manager 212 of FIG. 2 selects the latest frame from each stream 401A-D when generated the rendered image stream 410. Thus, since frame 406E was received after frame 406D, frame 406E is include in frame 411E, and frame 406D is not included in frame 411E. By composition stream 410 in this manner, frame manager 212 of FIG. 2 improves the processing efficiency of client device 102, and improves the thermal sustainability of the client device 102.

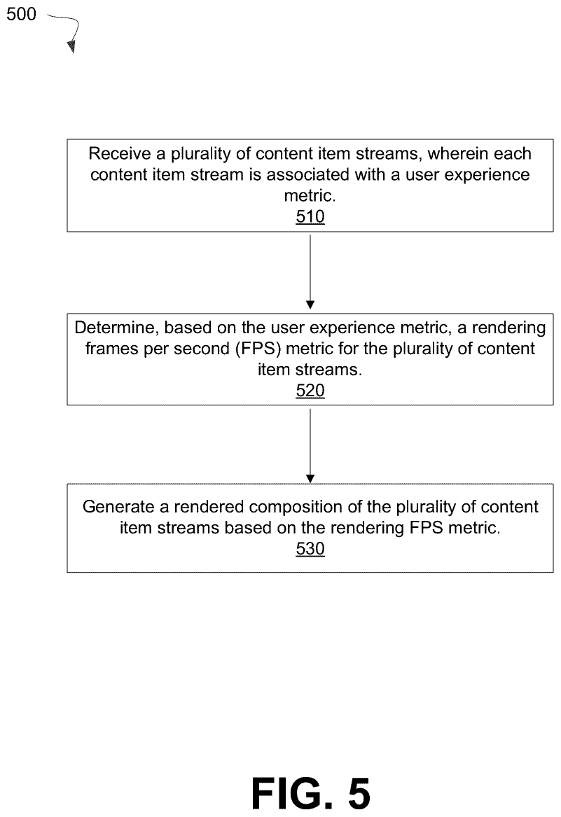

FIG. 5 depicts a flow diagram of a method 500 for generating a rendered composition of multiple content streams to display in a user interface, in accordance with implementations of the present disclosure. Method 500 may be performed by processing logic that may include hardware (circuitry, dedicated logic, etc.), software (e.g., instructions run on a processing device), or a combination thereof. In one implementation, some or all the operations of method 500 may be performed by one or more components of system 100 of FIG. 1 (e.g., platform 120, server 130, client device 102A-N, and/or platform manager 122). In one implementation, some or all of the operations of method 500 may be performed client devices 102A-N.

For simplicity of explanation, the method 500 of this disclosure is depicted and described as a series of acts. However, acts in accordance with this disclosure can occur in various orders and/or concurrently, and with other acts not presented and described herein. Furthermore, not all illustrated acts may be required to implement the method 500 in accordance with the disclosed subject matter. In addition, those skilled in the art will understand and appreciate that the method 500 could alternatively be represented as a series of interrelated states via a state diagram or events. Additionally, it should be appreciated that the method 500 disclosed in this specification is capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At block 510, the processing logic receives a plurality of content item streams. Each content item stream is associated with a user experience metric. The content item streams can be received from other client devices, from a server, and/or application(s) running on the device. The user experience metric can represent the frame rate experienced by a viewer of the content item stream. For example, the user experience metric can reflect one of a minimum frame rate or a harmonic frame rate of the corresponding content item stream, determined over a period of time. That is, in some embodiments, the user experience metric can be the lowest frame rate (e.g., FPS) of the content item stream over a time period. Because a change in frame rate can be noticeable to viewers, using the lowest FPS of a content stream, determined over a period of time, can provide a smoother and more fluid experience. In some embodiments, the lowest FPS can satisfy a condition, such as being above a certain threshold or within a certain range, to account for outliers. The user experience metric can be updated as content item stream is being received. For example, the user experience metric can be updated on a predetermined schedule (e.g., every 3 seconds, or every 30 seconds). Additionally or alternatively, the user experience metric can be updated when the processing logic determines a drastic change in frame rate of the received content item stream (e.g., the frame rate of the received content item stream changes by more than threshold amount or percentage over a time period).

At block 520, processing logic determines, based on the user experience metric, a rendering frames per second (FPS) metric for the plurality of content item streams. In some embodiments, to determine the rendering FPS metric for the plurality of content item streams, the processing logic can determine a stabilized FPS metric for each of the content item streams. The stabilized FPS metric can be based on the user experience metric. In some embodiments, to determine the stabilized FPS metric for each content item stream, the processing logic can identify a plurality of actual frame rates over a period of time. The processing logic can then identify the lowest of the plurality of actual frame rates. The plurality of actual frame rates can represent the dynamic frames per second of the received content item streams. In some embodiments, the lowest of the actual frame rates can satisfy a condition, such as being above a certain threshold or being within a specific range of frame rates. The condition accounts for potential outliers in the actual frame rate of the content item stream.

In some embodiments, the processing logic can identify a display setting associated with a user interface displaying the plurality of content item streams. The display setting can be, for example, whether the user interface is displaying an application in full-screen mode (e.g., as illustrated in UI 300 of FIG. 3A), or whether there are additional UI elements displayed in the UI (as illustrated in UI 350 of FIG. 3B). The display setting can be the display resolution, the brightness, color, scale, layout, and/or orientation setting of the display device (e.g., display 103A-N of FIG. 1, or display device 240 of FIG. 2). In the example of a video conference, a display setting can be whether the video conference is being displayed in speaker mode (e.g., as illustrated in UI 350 of FIG. 3B), or in gallery mode (e.g., as illustrated in UI 300 of FIG. 3A). Thus, the display setting can indicate whether and which content streams take up more space in the UI. Based on the display setting, the processing logic can determine a weighting factor for each content item stream. The rendering FPS metric can then be determined by combining (e.g., averaging) the stabilized FPS metrics of the content item streams according to the weighting factors.

In some embodiments, the rendering FPS can be the highest stabilized FPS metrics of the content item streams, the lowest stabilized FPS metrics of the content item streams, the median of the stabilized FPS metrics of the content item streams, or the average of the stabilized FPS metrics of the content item streams.

At block 530, processing logic generates a rendered composition of the plurality of content item streams based on the rendering FPS metric. In generating the rendered composition, the processing logic can identify one or more content frames for each content item stream. In some embodiments, the processing logic can identifying whether at least one new content frame is received from each of the plurality of content item streams. That is, in some embodiments, the processing logic can wait until a content frame is received from each content item stream before generating the rendered composition.

In some embodiments, the identified one or more content frames can be received after the most recent rendered composition has been generated. The processing logic can further identify, for each content item stream, the most recent content frame of the one or more content frames. In some embodiments, the most recent content frame can be the most recently generated content frame. For example, each content frame can have a timestamp indicating the time it was generated, and the processing logic can identify the most recently generated content frame based on the timestamp. In some embodiments, the most recent content frame can be the most recently received content frame. For example, each content frame can have a timestamp indicating the time it was received, and the processing logic can identify the most recently received content frame based on the timestamp.

Responsive to determining, for each content item stream, that the most recent content frame satisfies a criterion, the processing logic can include the most content frame in the rendered composition. In some embodiments, the criterion can be satisfied by determining that the most recent content frame has not been included in a previous rendered composition of the plurality of content item streams. Thus, the rendered composition can include new and latest content frames that have not been included in previous composition renderings. In some embodiments, the processing logic can discard content frames if more than one frame is received after the previous rendered composition is generated. As an illustrative example, in generating rendered frame 411E, frame 406D of stream 401D of FIG. 4 can be discarded since two frames (406D and 406E) are received since the last rendered composition 411D was generated.

In generating the rendered composition, the processing logic can synchronize the content frames from each of the content item streams based on the rendering FPS metric. The processing logic can then combine the synchronized content frames. In some embodiments, the processing logic determines a target refresh rate based on the rendering FPS metric. The target refresh rate can be the VSYNC rate, and can match the rendering FPS metric, or can closely match the FPS metric. In some embodiments, the processing logic can receive target refresh rate requests from multiple sources, and can determine the target refresh rate based on an aggregation of the multiple target refresh rates requests. The processing logic can adjust the target refresh rate on a predetermined schedule (e.g., every 2 minutes), and/or if multiple target refresh rate votes or requests are received within a period of time (e.g., within 30 seconds).

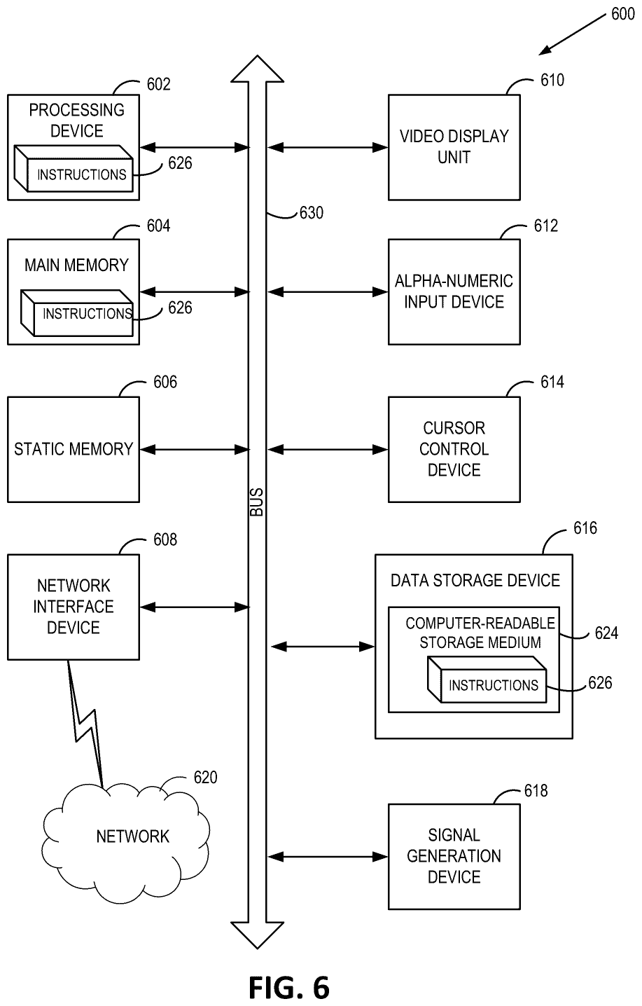

FIG. 6 is a block diagram illustrating an exemplary computer system, in accordance with implementations of the present disclosure. The computer system 600 can be the server 130 or client devices 102A-N in FIG. 1. The machine can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processing device (processor) 602, a main memory 604 (e.g., volatile memory, read-only memory (ROM), flash memory, dynamic random access memory (DRAM) such as synchronous DRAM (SDRAM), double data rate (DDR SDRAM), or DRAM (RDRAM), etc.), a static memory 606 (e.g., non-volatile memory, flash memory, static random access memory (SRAM), etc.), and a data storage device 616, which communicate with each other via a bus 630.

Processor (processing device) 602 represents one or more general-purpose processing devices such as a microprocessor, central processing unit, or the like. More particularly, the processor 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 can also be one or more special-purpose processing devices such as an application specific integrated circuit (ASIC), a field programmable gate array (FPGA), a digital signal processor (DSP), network processor, or the like. The processor 602 is configured to execute instructions 626 (e.g., for providing an efficient and energy-aware rendering and display pipeline for a multi-stream user interface) for performing the operations discussed herein.

The computer system 600 can further include a network interface device 608. The computer system 600 also can include a video display unit 610 (e.g., a liquid crystal display (LCD) or a cathode ray tube (CRT)), an input device 612 (e.g., a keyboard, and alphanumeric keyboard, a motion sensing input device, touch screen), a cursor control device 614 (e.g., a mouse), and a signal generation device 618 (e.g., a speaker).

The data storage device 616 can include a non-transitory machine-readable storage medium 624 (also computer-readable storage medium) on which is stored one or more sets of instructions 626 (e.g., for providing an efficient and energy-aware rendering and display pipeline for a multi-stream user interfaces) embodying any one or more of the methodologies or functions described herein. The instructions can also reside, completely or at least partially, within the main memory 604 and/or within the processor 602 during execution thereof by the computer system 600, the main memory 604 and the processor 602 also constituting machine-readable storage media. The instructions can further be transmitted or received over a network 620 via the network interface device 608.

In one implementation, the instructions 626 include instructions for providing an efficient and energy-aware rendering and display pipeline for a multi-stream user interface. While the computer-readable storage medium 624 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
receiving a plurality of content item streams, wherein each content item stream is associated with a user experience metric;
determining, based on the user experience metric, a rendering frames per second (FPS) metric for the plurality of content item streams; and
generating a rendered composition of the plurality of content item streams based on the rendering FPS metric.

2. The method of claim 1, wherein generating the rendered composition of the plurality of content item streams based on the rendering FPS metric comprises:
identifying, for each content item stream of the plurality of content item streams, one or more content frames;
identifying, for each content item stream of the plurality of content item streams, a most recent content frame of the one or more content frames; and
responsive to determining, for each content item stream of the plurality of content item streams, that the most recent content frame satisfies a criterion, including the most recent content frame in the rendered composition.

3. The method of claim 2, wherein the criterion is satisfied responsive to determining that the most recent content frame has not been included in a previous rendered composition of the plurality of content item streams.

4. The method of claim 1, further comprising:
determining a target refresh rate based on the rendering FPS metric.

5. The method of claim 1, wherein the user experience metric reflects one of a minimum frame rate or a harmonic frame rate of the corresponding content item stream, determined over a period of time.

6. The method of claim 1, wherein determining the rendering FPS metric for the plurality of content item streams comprises:
determining, based on the user experience metric, a stabilized FPS metric for each content item stream;
identifying a display setting associated with a user interface displaying the plurality of content item streams;
determining, based on the display setting, a weighting factor for each content item stream; and
combining the stabilized FPS metrics of the plurality of content item streams according to the weighting factors.

7. The method of claim 6, wherein determining the stabilized FPS metric for each content item stream comprises:
identifying, for each content item stream, a plurality of actual frame rates over a period of time; and
identifying, for each content item stream, a lowest of the plurality of actual frame rates, wherein the lowest of the plurality of actual frame rates satisfies a threshold condition.

8. The method of claim 6, wherein the rendering FPS is one of: a highest of the stabilized FPS metrics of the plurality of content item streams, a lowest of the stabilized FPS metrics of the plurality of content item streams, a median of the stabilized FPS metrics of the plurality of content item streams, or an average of the stabilized FPS metrics of the plurality of content item streams.

9. The method of claim 1, wherein generating the rendered composition of the plurality of content item streams comprises:
synchronizing content frames from each content item stream based on the rendering FPS metric; and
combining the synchronized content frames.

10. A system comprising:
a memory device; and
a processing device coupled to the memory device, the processing device to perform operations comprising:
receiving a plurality of content item streams, wherein each content item stream is associated with a user experience metric;
determining, based on the user experience metric, a rendering frames per second (FPS) metric for the plurality of content item streams; and
generating a rendered composition of the plurality of content item streams based on the rendering FPS metric.

11. The system of claim 10, wherein generating the rendered composition of the plurality of content item streams based on the rendering FPS metric comprises:
identifying, for each content item stream of the plurality of content item streams, one or more content frames;
identifying, for each content item stream of the plurality of content item streams, a most recent content frame of the one or more content frames; and
responsive to determining, for each content item stream of the plurality of content item streams, that the most recent content frame satisfies a criterion, including the most recent content frame in the rendered composition.

12. The system of claim 11, wherein the criterion is satisfied responsive to determining that the most recent content frame has not been included in a previous rendered composition of the plurality of content item streams.

13. The system of claim 10, wherein the processing device is to perform operations further comprising:
determining a target refresh rate based on the rendering FPS metric.

14. The system of claim 10, wherein the user experience metric reflects one of a minimum frame rate or a harmonic frame rate of the corresponding content item stream, determined over a period of time.

15. The system of claim 10, wherein determining the rendering FPS metric for the plurality of content item streams comprises:
determining, based on the user experience metric, a stabilized FPS metric for each content item stream;
identifying a display setting associated with a user interface displaying the plurality of content item streams;
determining, based on the display setting, a weighting factor for each content item stream; and
combining the stabilized FPS metrics of the plurality of content item streams according to the weighting factors.

16. The system of claim 15, wherein determining the stabilized FPS metric for each content item stream comprises:
identifying, for each content item stream, a plurality of actual frame rates over a period of time; and
identifying, for each content item stream, a lowest of the plurality of actual frame rates, wherein the lowest of the plurality of actual frame rates satisfies a threshold condition.

17. The system of claim 15, wherein the rendering FPS is one of: a highest of the stabilized FPS metrics of the plurality of content item streams, a lowest of the stabilized FPS metrics of the plurality of content item streams, a median of the stabilized FPS metrics of the plurality of content item streams, or an average of the stabilized FPS metrics of the plurality of content item streams.

18. The system of claim 10, wherein generating the rendered composition of the plurality of content item streams comprises:
synchronizing content frames from each content item stream based on the rendering FPS metric; and
combining the synchronized content frames.

19. A non-transitory computer readable storage medium comprising instructions for a server that, when executed by a processing device, cause the processing device to perform operations comprising:
receiving a plurality of content item streams, wherein each content item stream is associated with a user experience metric;
determining, based on the user experience metric, a rendering frames per second (FPS) metric for the plurality of content item streams; and
generating a rendered composition of the plurality of content item streams based on the rendering FPS metric.

20. The non-transitory computer readable storage medium of claim 19, wherein generating the rendered composition of the plurality of content item streams based on the rendering FPS metric comprises:
identifying, for each content item stream of the plurality of content item streams, one or more content frames;
identifying, for each content item stream of the plurality of content item streams, a most recent content frame of the one or more content frames; and
responsive to determining, for each content item stream of the plurality of content item streams, that the most recent content frame satisfies a criterion, including the most recent content frame in the rendered composition.
